(19) United States
(12) Patent Application Publication
(10) Pub. No.: US 2014/0181651 A1
(43) Pub. Date: Jun. 26, 2014

(54) USER SPECIFIC HELP

(71) Applicant: HONDA MOTOR CO., LTD., Tokyo (JP)

(72) Inventors: Stuart Masakazu Yamamoto, Hacienda Heights, CA (US); Ritchie Winson Huang, Torrance, CA (US); Pedram Vaghefinazari, Long Beach, CA (US)

(21) Appl. No.: 13/723,121

(22) Filed: Dec. 20, 2012

(51) Int. Cl. G06F 3/0481

(52) U.S. Cl. CPC G06F 3/0481
USPC 715/705

(57) ABSTRACT

A help module provides help content to a user by determining an application for which help should be presented. In one embodiment, the user requests help for a particular application and the help module determines the application for which help should be presented based on the received request. Alternatively, the help module selects an application from a pre-determined list of applications as the application for which help should be presented. The help module retrieves user data for the determined application and generates help content that includes at least part of the retrieved user data. The generated help is then transmitted by the help module for presentation to the user.

### BACKGROUND

1. Field of Disclosure

The disclosure generally relates to providing help to a user for applications, in particular to providing personalized help to the user.

2. Description of the Related Art

Help menus and help pages have long been part of applications. These menus and pages provide valuable information to a user and help the user navigate or learn various features of an application. Some of these pages provide detailed information, directing the user step-by-step on how to use a particular feature. While these menus provide detailed help, the menus do not do a particularly good job of connecting with a user; imparting knowledge to a user in a manner that is likely to stay with the user after the user closes the help page.

### SUMMARY

Embodiments of the system provide help content to a user by determining an application for which help should be presented. In one embodiment, the user requests help for a particular application and the system determines the application for which help should be presented based on the received request. Alternatively, the system selects an application from a pre-determined list of applications as the application for which help should be presented. The system retrieves user data for the determined application and generates help content that includes at least part of the retrieved user data. The generated help is then transmitted by the system for presentation to the user.

Other embodiments of the invention include a computer-readable medium that store instructions for implementing the above described functions of the system, and a computer-implemented method that includes steps for performing the above described functions.

### BRIEF DESCRIPTION OF DRAWINGS

FIG. 1 is a block diagram illustrating a computing environment for providing personalized help according to one embodiment.

FIG. 2 is a block diagram illustrating a help module in the computing environment for providing personalized help according to one embodiment.

FIG. 3 is a flow diagram illustrating a method for providing personalized help according to one embodiment.

FIG. 4A illustrates a user interface screen displaying personalized help for an application selected from a pre-determined list of applications according to one embodiment.

FIG. 4B illustrates a user interface screen displaying personalized help for a music application according to one embodiment.

FIG. 4C illustrates a user interface screen displaying personalized help for a phone application according to one embodiment.

### DETAILED DESCRIPTION

The computing environment described herein provides personalized help to a user. The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### System Environment

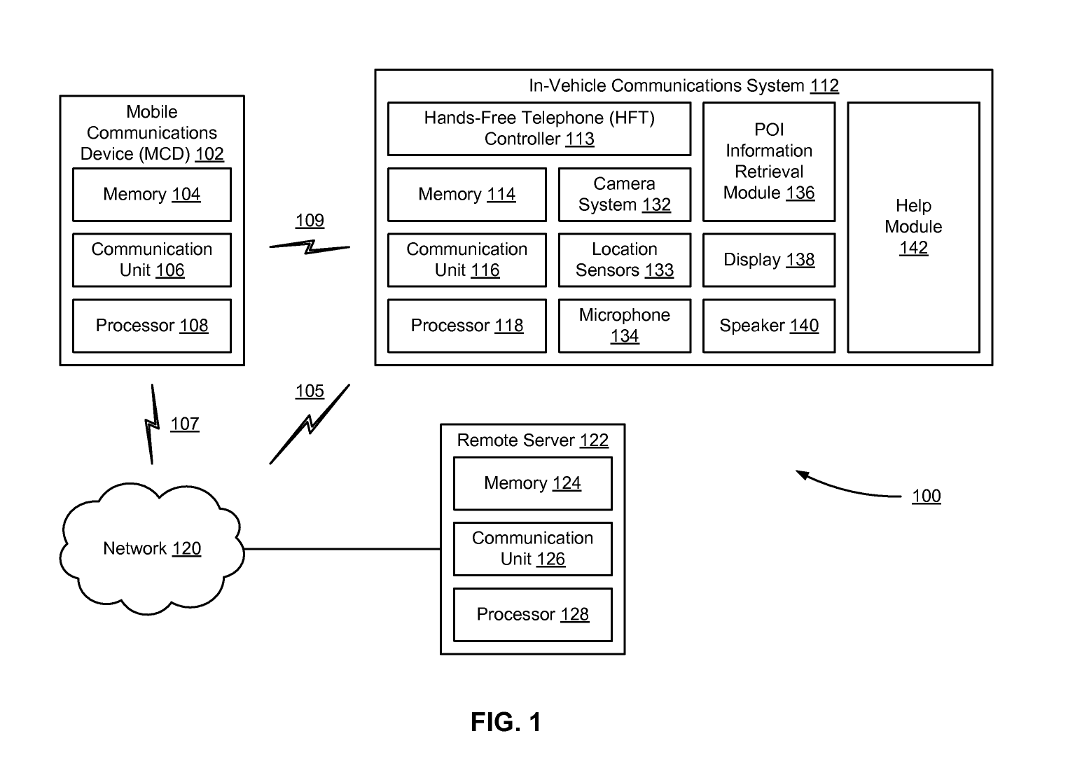

FIG. 1 illustrates an exemplary operating environment 100 for various embodiments. The operating environment 100 may include an in-vehicle communications system 112. One example of such a system is an in-vehicle hands free telephone (HFT) controller 113 which will be used as an example herein for ease of discussion. The operating environment 100 may also include a wireless mobile communication device (MCD) 102, a communication link 105 for communications between the in-vehicle system 112 and a network 120, a short-range communication link 109 for communication between the in-vehicle system 112 and the wireless mobile communication device 102, a wireless networking communication link 107 between the wireless mobile communication device 102 and the network 120, and a POI data server 122 connected to the network 120. The communication links described herein can directly or indirectly connect these devices. The network 120 can be a wireless communication network such as a cellular network comprised of multiple base stations, controllers, and a core network that typically includes multiple switching entities and gateways, for example.

The functions described herein are set forth as being performed by a device in the operating environment 100 (e.g., the in-vehicle communication system 112, the MCD 102, and/or the remote server 122). In embodiments, these functions can be performed in any of these devices or in any combination of these devices and/or other devices residing in or outside operating environment 100.

The operating environment 100 includes a help module 142 for providing personalized help to a user. The help module 142 may be a computing device with at least a processor and a memory configured to provide personalized help, or may be a non-transitory computer readable medium storing instructions for providing personalized help.

To provide personalized help for an application (e.g., applications used in a vehicle like a navigation application), the help module 142 integrates user data for an application into help content for the application. An application receives and stores user data for various users. This user data includes data that is relevant to a particular user of the application (e.g., data entered into the application by the user) instead of generic data relevant to every user (e.g., a graphic image in a user interface that is displayed with the interface to every user). In one embodiment, data entered or created by a user using the application is user data for a group of users using the application.

The help module 142 retrieves user data previously stored for the application and generates help content that includes at least part of the retrieved user data. For example, the help module 142 retrieves addresses previously entered by a user in a navigation system (not shown) and integrates the retrieved addresses into help content for interacting with the navigation system. The generated help content may therefore include the following language: “you can say the full address in one string starting from the house number and ending with the state from this screen. For example you can say 1100 Wilshire Blvd., Los Angeles, Calif.” In this generated content, the address “1100 Wilshire Blvd., Los Angeles, Calif.” is an address that was previously provided to the navigation system by a user.

Similarly, help module 142 may generate help content for integrating a voice recognition feature into a phone application. The generated help content may include instructions to call a particular number or a particular friend, wherein the number and the friend used in the instructions is a previously dialed number or a contact saved in the user's phone.

In one embodiment, the help module 142 may receive from a navigation system the current location of the vehicle that includes the navigation system, and the help module 142 may integrate the received current location into help content. For example, a tutorial on how to search for points of interest (e.g., bank in a particular neighborhood) or a place by name (e.g., Starbucks in a particular neighborhood) may insert the city or town of the current location into the tutorial. If the current location is Mountain View, Calif., the tutorial may include language like “you can search for a point of interest in a particular town by indicating the point of interest and town. For example you can say Banks in Mountain View, Calif.”

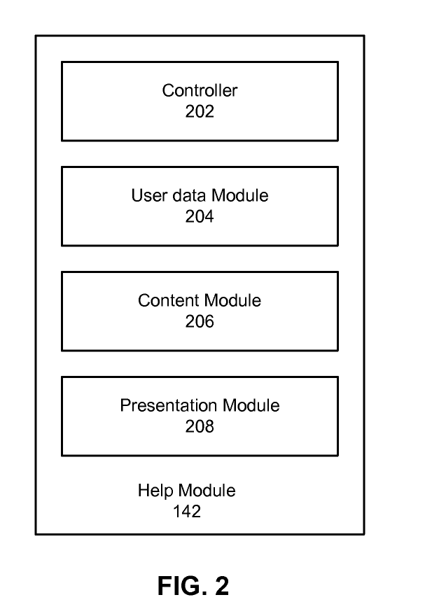

In this manner, the help module 142 integrates user data or current location into help content. One of the many benefits of generating such help content is that the content is likely to resonate with a user because the content includes user data or current location that is more likely to be familiar to the user instead of static data that may be completely irrelevant to the user. The help module 142 is further described in FIG. 2 below.

The operating environment 100 further includes input devices, such as a camera system 132, location sensors 133, and a microphone 134. The camera system 132, location sensors 133, and/or microphone 134 can be part of the in-vehicle system 112 (as shown in FIG. 1) or can be in the MCD 102 (not shown), for example. In one embodiment, the camera system 132 includes a sensor that captures physical signals from within the vehicle (e.g., a time of flight camera, an infrared sensor, a traditional camera, etc). The camera system 132 is positioned to capture physical signals from a user such as hand or arm gestures from a driver or passenger. The camera system 132 can include multiple cameras positioned to capture physical signals from various positions in the vehicle, e.g., driver seat, front passenger seat, second row seats, etc. Alternatively, the camera system 132 may be a single camera which is focused on one position (e.g., the driver), has a wide field of view, and can receive signals from more than one occupant of the vehicle, or can change its field of view to receive signals from different occupant positions.

In another embodiment, the camera system 132 is part of the MCD 102 (e.g., a camera incorporated into a smart phone), and the MCD 102 can be positioned so that the camera system 132 captures gestures performed by the occupant. For example, the camera system 132 can be mounted so that it faces the driver and can capture gestures by the driver. The camera system 132 may be positioned in the cabin or pointing toward the cabin and can be mounted on the ceiling, headrest, dashboard or other locations in/on the in-vehicle system 112 or MCD 102.

After capturing a physical signal, the camera system 132 outputs a data signal representing the physical signal. The format of the data signal may vary based on the type sensor(s) that were used to capture the physical signals. For example, if a traditional camera sensor was used to capture a visual representation of the physical signal, then the data signal may be an image or a sequence of images (e.g., a video). In embodiments where a different type of sensor is used, the data signal may be a more abstract or higher-level representation of the physical signal.

The location sensors 133 are physical sensors and communication devices that output data associated with the current location and orientation of the vehicle. For example, the location sensors 133 may include a device that receives signals from a global navigation satellite system (GNSS) or an electronic compass (e.g., a teslameter) that measures the orientation of the vehicle relative to the four cardinal directions. The location sensors 133 may also operate in conjunction with the communication unit 116 to receive location data associated with connected nodes in a cellular tower or wireless network. In another embodiment, some or all of the location sensors 133 may be incorporated into the MCD 102 instead of the vehicle.

The microphone 134 captures audio signals from inside the vehicle. In one embodiment, the microphone 134 can be positioned so that it is more sensitive to sound emanating from a particular position (e.g., the position of the driver) than other positions (e.g., other occupants). The microphone 134 can be a standard microphone that is incorporated into the vehicle, or it can be a microphone incorporated into the MCD 102. The microphone 134 can be mounted so that it captures voice signals from the driver. For example, the microphone 134 may be positioned in the cabin or pointing toward the cabin and can be mounted on the ceiling, headrest, dashboard or other locations in/on the vehicle or MCD 102.

The POI information retrieval module 136 retrieves information related to one or more POIs based on input from the camera system 132 and (optionally) the microphone 134. After performing the search, the module 136 sends the result to the display 138 and/or speaker 140 so that the result can be provided to the user.

The operating environment 100 also includes output devices, such as a display 138 and a speaker 140. The display 138 receives and displays a video signal. The display 138 may be incorporated into the vehicle (e.g., an LCD screen in the central console, a HUD on the windshield), or it may be part of the MCD 102 (e.g., a touchscreen on a smartphone). The speaker 140 receives and plays back an audio signal. Similar to the display 138, the speaker 140 may be incorporated into the vehicle, or it can be a speaker incorporated into the MCD 102.

The in-vehicle hands-free telephone (HFT) controller 113 and wireless mobile communication device (MCD) 102 may communicate with each other via a short-range communication link 109 which uses short-range communication technology, such as, for example, Bluetooth® technology or other short-range communication technology, for example, Universal Serial Bus (USB). The HFT controller 113 and mobile communications device 102 may connect, or pair, with each other via short-range communication link 109. In an embodiment the vehicle can include a communications unit 116 that interacts with the HFT controller 113 to engage in the short range communications, a memory unit device 114, and a processor 118. The HFT controller 113 can be part of a vehicle's telematics system which includes memory/storage, processor(s) and communication unit(s). The HFT controller 113 can utilize the vehicle's telematics unit to assist in performing various functions. For example, the communications unit 116 and/or processor 118 can be part of the vehicle's telematics unit or can be a separate unit in the vehicle.

The processors 108, 118 and/or 128 process data signals and may comprise various computing architectures including a complex instruction set computer (CISC) architecture, a reduced instruction set computer (RISC) architecture, or an architecture implementing a combination of instruction sets. Although only a single processor is shown in each device in FIG. 1, multiple processors may be included in each device. The processors can comprise an arithmetic logic unit, a microprocessor, a general purpose computer, or some other information appliance equipped to transmit, receive and process electronic data signals from the memory 104, 114, 124, and other devices both shown and not shown in the figures.

Examples of a wireless mobile communication device (MCD) 102 include a cellular phone, personal device assistant (PDA), smart phone, pocket personal computer (PC), laptop computer, tablet computer, smart watch or other devices having a processor, communications capability and are easily transportable, for example. The MCD 102 includes a communications unit 106, a memory unit device 104, and a processor 108. The MCD 102 also includes an operating system and can include various applications either integrated into the operating system or stored in memory/storage 104 and executed by the processor 108. In a common form, an MCD application can be part of a larger suite of vehicle features and interactions. Examples of applications include applications available for the iPhone™ that is commercially available from Apple Computer, Cupertino, Calif., applications for phones running the Android™ operating system that is commercially available from Google, Inc., Mountain View, Calif., applications for BlackBerry devices, available from Research In Motion Ltd., Waterloo, Ontario, Canada, and/or applications available for Windows Mobile devices, available from Microsoft Corp., Redmond, Wash.

In alternate embodiments, the mobile communication device 102 can be used in conjunction with a communication device embedded in the vehicle, such as a vehicle-embedded phone, a wireless network card, or other device (e.g., a Wi-Fi capable device). For ease of discussion, the description herein describes the operation of the embodiments with respect to an embodiment using a mobile communication device 102. However, this is not intended to limit the scope of the embodiments and it is envisioned that other embodiments operate using other communication systems between the in-vehicle system 112 and the network 120, examples of which are described herein.

The mobile communication device 102 and the in-vehicle system 112 may exchange information via short-range communication link 109. The mobile communication device 102 may store information received from the in-vehicle system 112, and/or may provide the information (such as voice and/or gesture signals) to a remote processing device, such as, for example, the remote server 122, via the network 120. The remote server 122 can include a communications unit 126 to connect to the network 120, for example, a memory/storage unit 124 and a processor 128.

In some embodiments, the in-vehicle system 112 may provide information to the mobile communication device 102. The mobile communication device 102 may use that information to obtain additional information from the network 120 and/or the server 122. The additional information may also be obtained in response to providing information with respect to a prompt on wireless mobile communication device 102 from in-vehicle system 112.

The network 120 may include a wireless communication network, for example, a cellular telephony network, as well as one or more other networks, such as, the Internet, a public-switched telephone network (PSTN), a packet-switching network, a frame-relay network, a fiber-optic network, and/or other types of networks.

### Help Module

FIG. 2 is a block diagram illustrating a help module in the computing environment for providing personalized help according to one embodiment. The help module 142 includes a controller 202, user data module 204, content module 206 and presentation module 208.

The controller 202 receives a request for help from another module (like a touch screen controller or an interface module receiving input from a driver or a passenger), and the controller 202 determines the help content for the help request. In one embodiment, the controller 202 determines the application associated with the help request (e.g., the application for which help is sought). The controller 202 may receive the application's identification with the help request. Alternatively, the controller 202 queries the operating system or the state machine of the in-vehicle communication system 112 to determine the application for which help is sought. In another embodiment, the help request is not specific to a particular application and the controller 202 selects one of a pre-determined list of applications as the application associated with the help request. The controller 202 selects one of the applications randomly or based on another selection criterion like the most frequently used application or application with largest amount of user data. For example, a home-screen may display a number of applications, and the controller 202 may randomly select one of the displayed applications as the application for which dynamic help is presented on the home-screen.

To determine content for dynamic help, the controller 202 queries and receives help content for the associated application and the received help content is presented to the user. The controller 202 receives help content from the help content module 206.

The help content module 206 receives a request for help content for an application, generates help content, and transmits the generated help content to the controller 202. To generate help content, the help content module 206 requests and receives user data for the application from the user data module 204. The help content module 206 includes at least a part of received user data into help content. For example, the help content module may request user data for a phone application from the user data module 206, receive from the user data module 204 a user's contact's name and phone number, and include the received phone number into help content providing instructions for using voice commands for making a phone call. The generated help content may therefore state “you can say: 415-555-1212 to dial a number,” wherein the 415-555-1212 is a phone number received from the user data module 204.

The user data module 204 receives a request for an application's user data, retrieves the requested user data from the application, and transmits the retrieved user data to help content module 206. The user data module 204 retrieves user data from an application through an interface (e.g., an application programming interface) and transmits the received user data to the help content module 206. In one embodiment, user data for a particular application is stored at a pre-determined location and the user data module 204 retrieves the user data from the pre-determined location instead of requesting data from the application.

The presentation module 208 presents the help content to a user. The presentation module 208 may present the help content to the user through a display or through an audio device. When presented through an audio device, the help content includes a narrative that is recited to the user. When presented through a display, the help content may be displayed on a user interface.

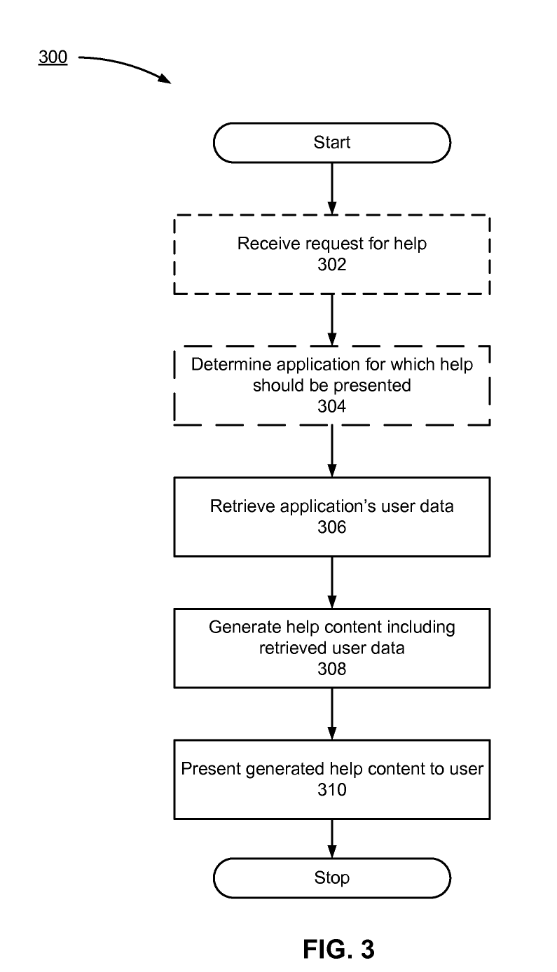

FIG. 3 is a flow diagram illustrating a method for providing personalized help according to one embodiment. The help module 142 receives 302 a request for help from a user and determines 304 the application for which help should be presented. In one embodiment, help content is presented to the user without receiving a request from the user. To determine the application for which help should be presented, the help module 142 determines whether a user has requested help for a particular application. If yes, the help module 142 determines that application as the application for which help should be presented. Otherwise, the help module 142 selects an application from a pre-determined list of applications as the application for which help should be presented.

Next, the help module 142 retrieves 306 user data for the determined application, and generates 308 help content including at least part of the retrieved user data. The help module 142 presents 310 the generated help content through an audio or a visual device.

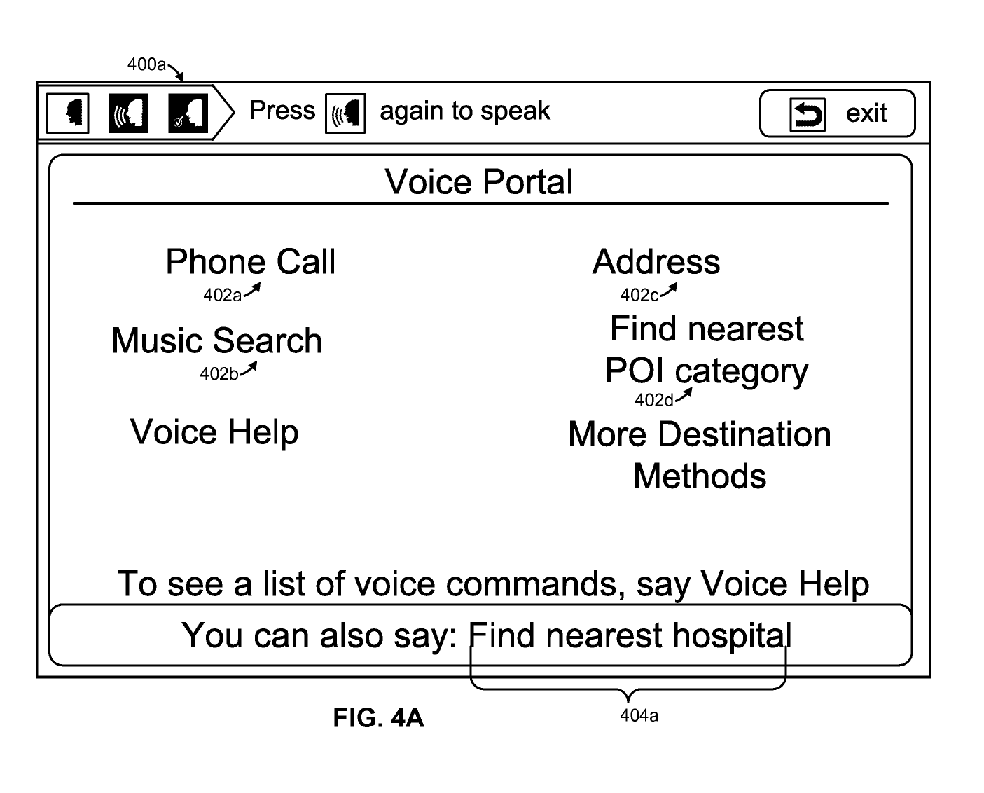

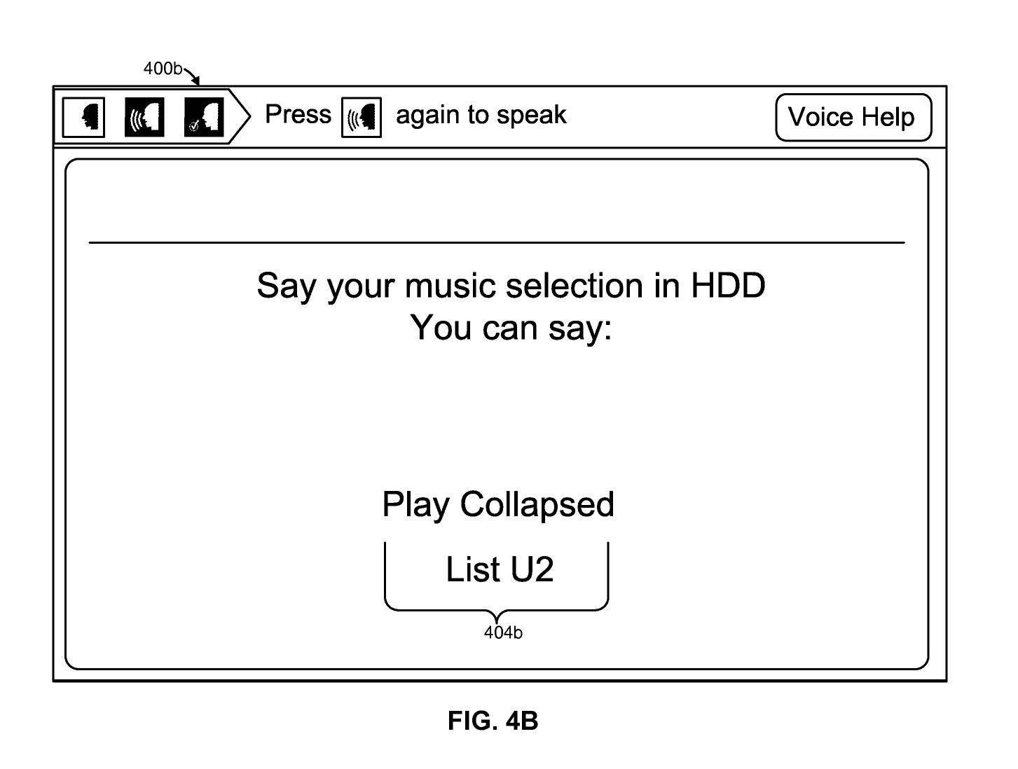

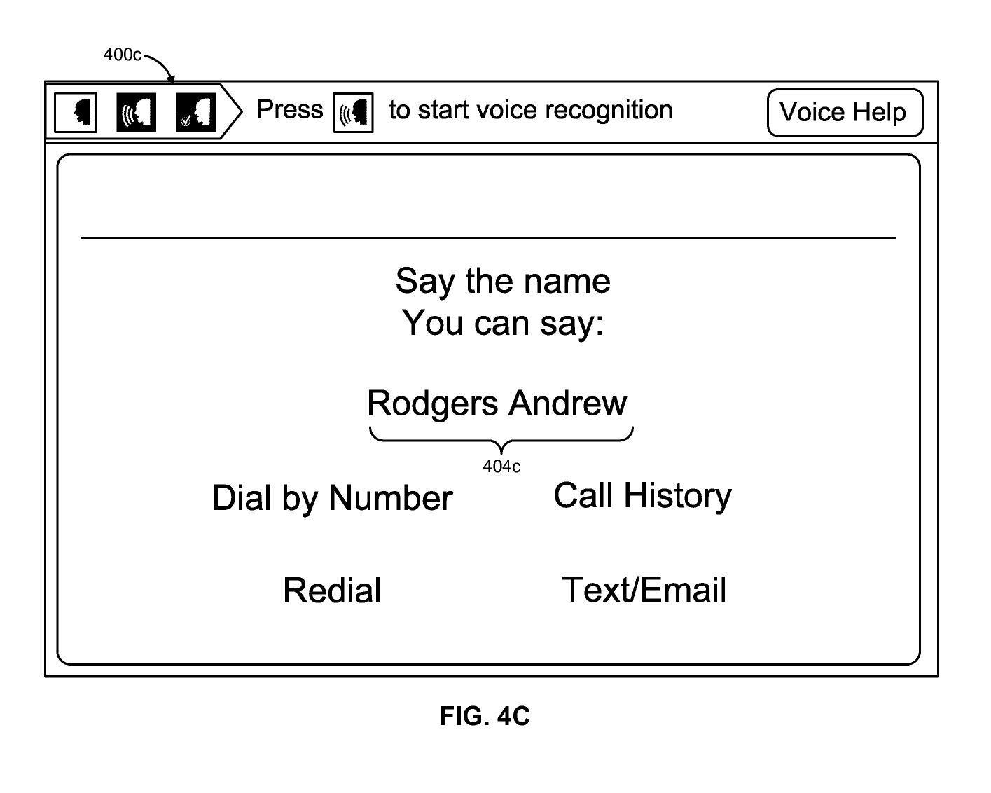

FIGS. 4A-C illustrate user interface screens including dynamically generated help content. Referring to FIG. 4A, it illustrates a user interface screen 400a displaying personalized help for an application selected from a pre-determined list of applications according to one embodiment. The screen 400a displays selectable objects 402a-d representing various applications or features of an application. A user may select a desired feature or application by selecting the corresponding object 402a-d. For example, the user may select the phone application by selecting icon 402a labeled “phone call,” the music search feature for a media application by selecting icon 402b labeled “music search,” a feature to request directions to a known address by selecting icon 402c labeled “address,” a feature to search for categories of nearest points of interest by selecting icon 402d labeled “find nearest POI category.”

The user interface screen 400a also includes dynamic help content 404a created by the help module 142. In this illustrated screen 400a, the user has not selected any particular application or feature and the help module 142 has selected the point of interest category search feature associated with the navigation application represented by icon 402d. In other words, the help module 142 has selected the navigation application from a pre-determined list of applications. The help module 142 has retrieved “hospital” as the point of interest category from the user data associated with the navigation system including the point of interest search category feature, and the help module 142 has inserted the retrieved user data (“hospital”) into dynamically generated help content 404a. The help module 142 presents this dynamically generated help content 404a to a user on a graphical user interface and alternatively as audio instructions.

FIG. 4B illustrates a user interface screen 400b displaying personalized help for a music application according to one embodiment. This illustrated screen 400b appears after the user has selected the music application. For this screen 400b, the help module 142 extracts a previously selected playlist titled “collapsed list U2” and creates dynamic help content 404b based on the extracted user data. In one embodiment, the help module 142 recites audio content including the dynamic help content 404b to the user.

FIG. 4C illustrates a user interface screen 400c displaying personalized help for a phone application according to one embodiment. This illustrated screen 400b appears after the user has selected the phone application. For this screen 400c, the help module 142 extracts a contact name “Rodgers Andrew” stored as user data in association with the phone application. The help module 142 creates dynamic help content 404c based on the extracted contact name and presents it to the user as part of screen 400c. In one embodiment, the help module 142 recites audio content including the dynamic help content 404c to the user.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof. One of ordinary skill in the art will understand that the hardware, implementing the described modules, includes at least one processor and a memory, the memory comprising instructions to execute the described functionality of the modules.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for providing help content, the method comprising:
determining an application in a vehicle for which help should be presented;
retrieving user data for the determined application, the user data including data associated with a particular user of the determined application;
generating help content for the determined application, the generated help content including at least a part of the user data; and
transmitting the generated help content for presentation to the user.

2. The computer-implemented method of claim 1, wherein determining the application for which help should be presented comprises selecting the application from a pre-determined list of applications.

3. The computer-implemented method of claim 1, wherein the user data is data provided by a user of the determined application.

4. The computer-implemented method of claim 1, wherein the user data is not generic data relevant to every user of the determined application.

5. The computer-implemented method of claim 1, further comprising
receiving a request for help for the application from the user; wherein
determining an application for which help should be presented comprises determining the application based on the received request.

6. The computer-implemented method of claim 1, wherein the help content is presented to the user as audio content.

7. The computer-implemented method of claim 1, wherein the help content is presented to the user as visual content.

8. A computer program product for providing help content, the computer program product comprising a non-transitory computer-readable storage medium including computer program code for:
determining an application in a vehicle for which help should be presented;
retrieving user data for the determined application, the user data including data associated with a particular user of the determined application;
generating help content for the determined application, the generated help content including at least a part of the user data; and
transmitting the generated help content for presentation to the user.

9. The computer program product of claim 8, wherein determining the application for which help should be presented comprises selecting the application from a pre-determined list of applications.

10. The computer program product of claim 8, wherein the user data is data provided by a user of the determined application.

11. The computer program product of claim 8, wherein the user data is not generic data relevant to every user of the determined application.

12. The computer program product of claim 8, further comprising computer program code for:
receiving a request for help for the application from the user; wherein
determining an application for which help should be presented comprises determining the application based on the received request.

13. The computer program product of claim 8, wherein the help content is presented to the user as audio content.

14. The computer program product of claim 8, wherein the help content is presented to the user as visual content.

15. A computer system for providing help content, the computer system comprising a processor and a non-transitory computer readable medium, the computer readable medium including computer program code for:
determining an application in a vehicle for which help should be presented;
retrieving user data for the determined application, the user data including data associated with a particular user of the determined application;
generating help content for the determined application, the generated help content including at least a part of the user data; and
transmitting the generated help content for presentation to the user.

16. The computer system of claim 15, wherein determining the application for which help should be presented comprises selecting the application from a pre-determined list of applications.

17. The computer system of claim 15, wherein the user data is data provided by a user of the determined application.

18. The computer system of claim 15, wherein the user data is not generic data relevant to every user of the determined application.

19. The computer system of claim 15, further comprising computer program code for:
receiving a request for help for the application from the user; wherein
determining an application for which help should be presented comprises determining the application based on the received request.

20. The computer system of claim 15, wherein the help content is presented to the user as audio content.
